(19) United States
(12) Patent Application Publication
(10) Pub. No.: US 2014/0036507 A1
(43) Pub. Date: Feb. 6, 2014

(54) ELECTRONIC DEVICE ENCLOSURE WITH MEDIA-SYNCHRONIZED LIGHTING

(71) Applicants: Hong Fu Jin Precision Industry (WuHan) Co., Ltd., (US); HON HAI PRECISION INDUSTRY CO., LTD., New Taipei (TW)

(72) Inventors: YUN-LUNG CHEN, New Taipei (TW); LI TONG, Wuhan (CN); HAI-TAO SHAN, Wuhan (CN)

(73) Assignees: HON HAI PRECISION INDUSTRY CO., LTD., New Taipei (TW); HONG FU JIN PRECISION INDUSTRY (WUHAN) CO., LTD., Wuhan (CN)

(21) Appl. No.: 13/873,218

(22) Filed: Apr. 30, 2013

(30) Foreign Application Priority Data
Aug. 3, 2012 (CN) 201210274734X

(51) Int. Cl. F21V 8/00

(52) U.S. Cl. CPC G02B 6/0001
USPC 362/257

(57) ABSTRACT

An electronic device enclosure includes a front bezel defining a first slot and a second slot; and a light assembly secured to the front bezel and including a lamp duct, a light guiding board, and one or more LED lamps. The lamp duct and the light guiding board are secured to the front bezel. The lamp is secured to the lamp duct. The light guiding board includes a light guiding rib aligned with the first slot. The lamp emits light or different lights according to the volume and different types of media played by the electronic device light.

### BACKGROUND

1. Technical Field

The present disclosure relates to electronic device enclosures.

2. Description of Related Art

An electronic device, such as a computer, includes an enclosure for receiving electronic components. When the computer is operated to play music for example, if the appearance of the computer can be synchronously adjusted according to the music, it will be a better user experience. Therefore, there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of one embodiment of an electronic device enclosure showing a part of a front bezel.

FIG. 2 is similar to FIG. 1, but viewed from a different aspect.

FIG. 3 is an isometric view of a lamp duct of the electronic device enclosure of FIG. 1.

FIG. 4 is a partially assembled, isometric view of the electronic device enclosure of FIG. 1.

FIG. 5 is an enlarged view of a circled portion V of the electronic device enclosure of FIG. 1.

FIG. 6 is similar to FIG. 5, but viewed from a different aspect.

FIG. 7 is an assembled, isometric view of the electronic device enclosure of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

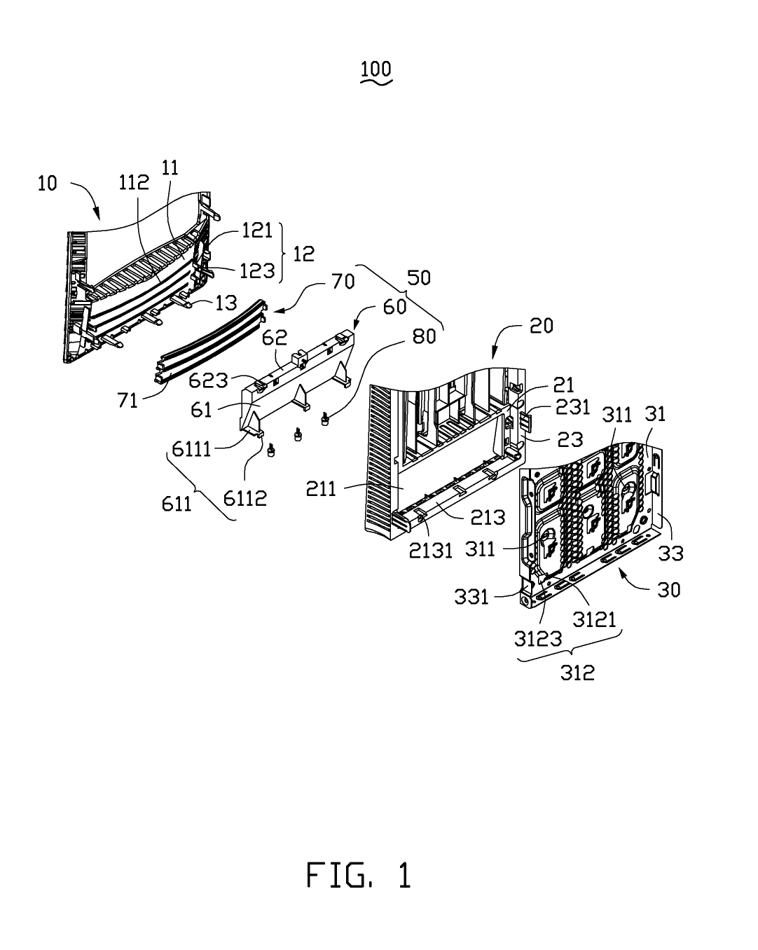

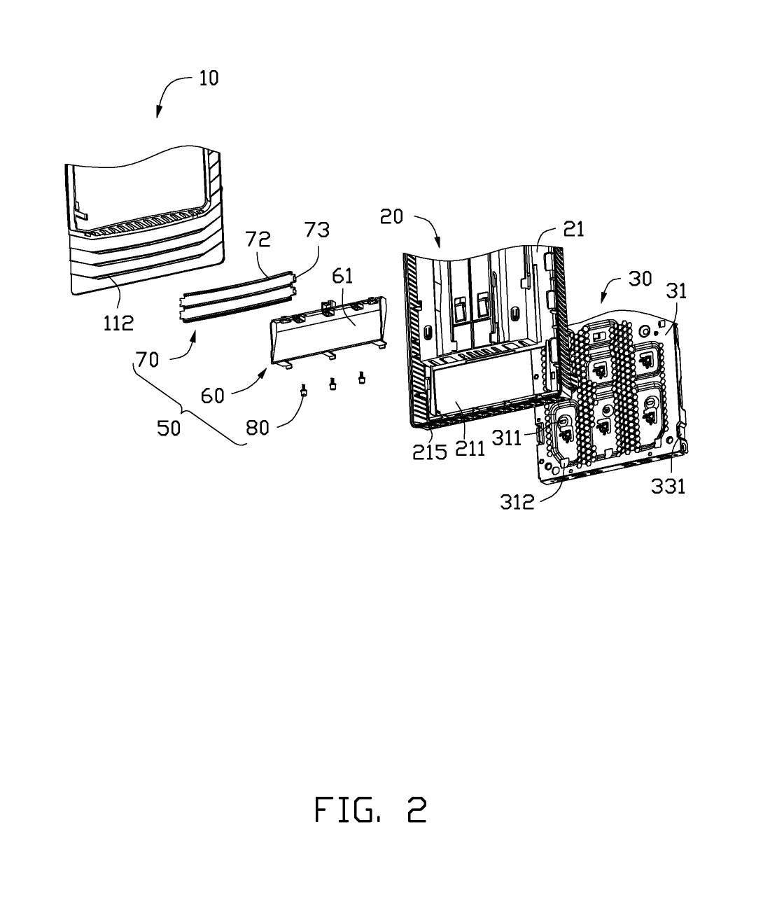

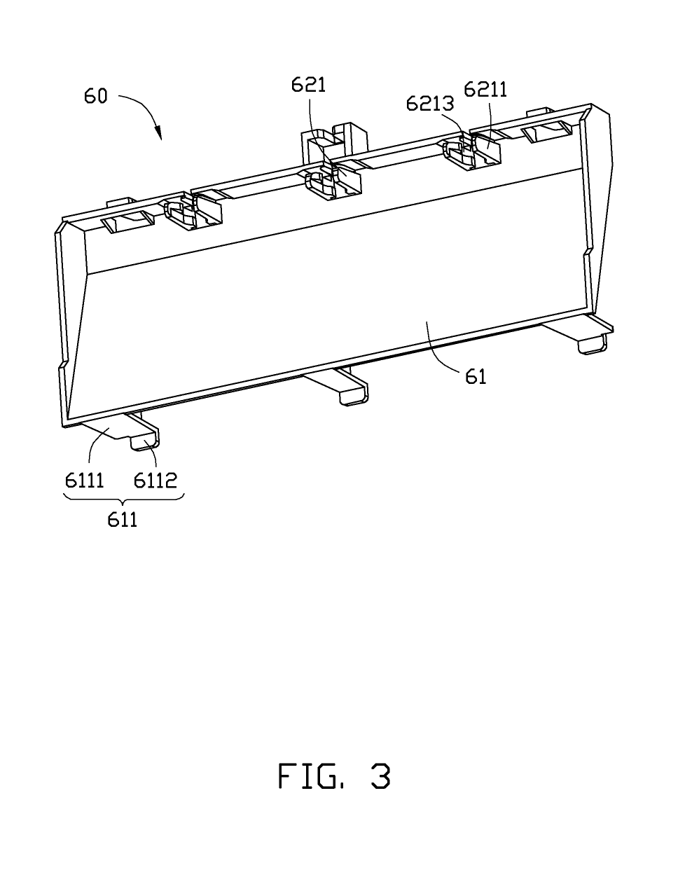

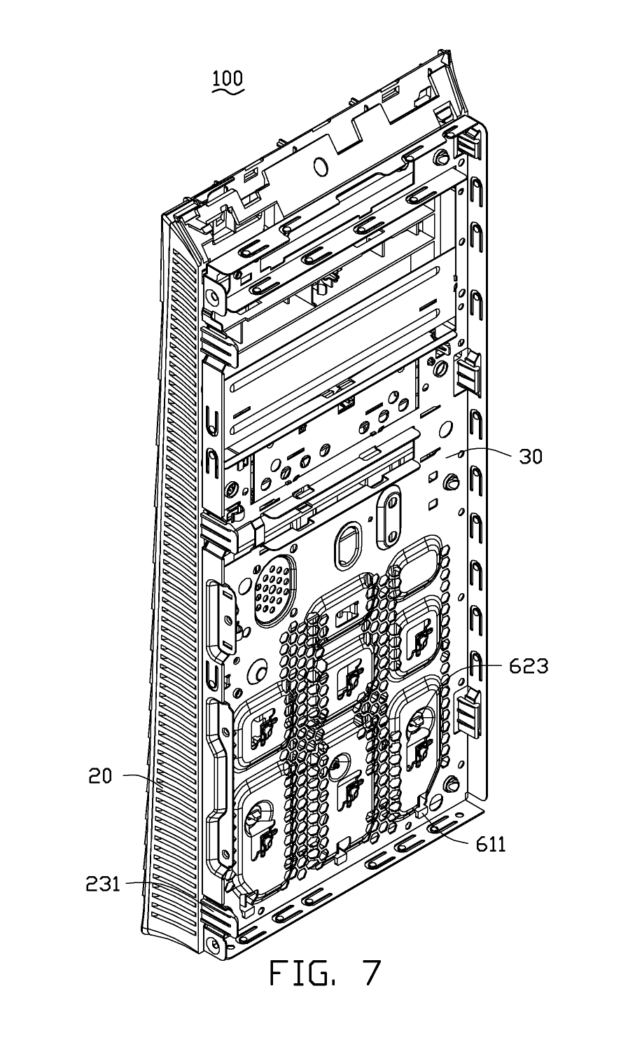

FIGS. 1-3 and 7 show one embodiment of an electronic device enclosure. The electronic device enclosure includes a front bezel 100 and a light assembly 50. In one embodiment, the electronic device is a computer.

The front bezel 100 includes a front plate 10, an installation plate 20, and a mounting plate 30.

The front plate 10 includes a first plate body 11, two latching portions 12 secured to opposite sides of the first plate body 11, and a plurality of first hooks 13 located on a bottom end of the first plate body 11. The first plate body 11 defines a plurality of first slots 112 extending horizontally. Each latching portion 12 includes a latching piece 121 and a latching block 123. In one embodiment, the latching piece 121 is substantially perpendicular to the first plate body 11. The latching block 123 extends from an end of the latching piece 121.

The installation plate 20 includes a second plate body 21 and two installation flanges 23 extending substantially perpendicularly from opposite edges of the second plate body 21. The second plate body 21 defines a receiving opening 211. An installation piece 213 is located on a bottom edge of the receiving opening 211 and defines a plurality of first latching slots 2131, each corresponding to each first hook 13. A second hook 231 is located on each of the two installation flanges 23. A bottom end of the second plate body 21 defines a plurality of second slots 215. An extending direction of each second slot 215 is substantially perpendicular to an extending direction of each first slot 112.

The mounting plate 20 includes a third plate body 31 and two mounting flanges 33 extending substantially perpendicularly from two opposite edges of the third plate body 31. The third plate body 31 defines two mounting holes 311 and a plurality of mounting slots 312. Each mounting slot 312 includes a guiding portion 3121 and a mounting portion 3123 communicating with the guiding portion 3121. Each mounting flange 33 defines a second latching slot 331 corresponding to each second hook 231.

The light assembly 50 includes a lamp duct 60, a light guiding board 70, and at least one lamp 80.

The lamp duct 60 includes a duct body 61 and a top wall 62 connected to the duct body 61. The top wall 62 includes a plurality of securing portions 621 for securing the lamp 80. Each mounting portion 621 includes two opposite resilient pieces 6211. Each resilient piece 6211 defines a receiving slot 6213. Two third hooks 623 extend outwardly from the top wall 62. Each third hook 623 engages in each mounting hole 311. A plurality of installation portions 611 is located on an outer surface of the duct body 61. Each installation portion 611 includes a connecting piece 6111 extending from the duct body 61 and a mounting piece 6112 extending downwards from the connecting piece 6111.

The light guiding board 70 includes a board body 71, a plurality of light guiding ribs 72, and a plurality of tabs 73 extending from side edges of the board body 71. A distance between two opposite tabs 73 is substantially equal to a distance between two opposite latching pieces 121.

In one embodiment, the lamp 80 is an LED lamp.

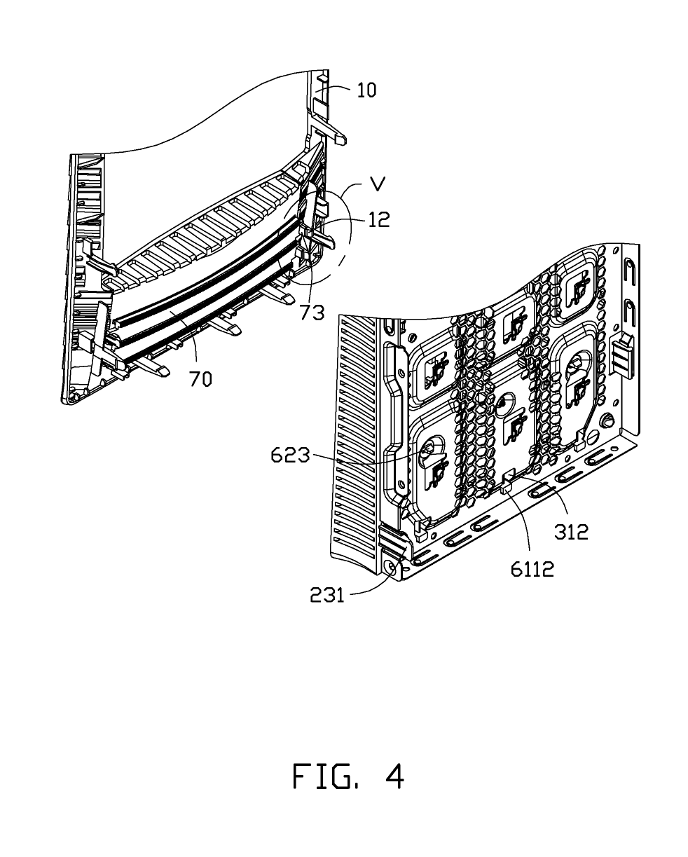

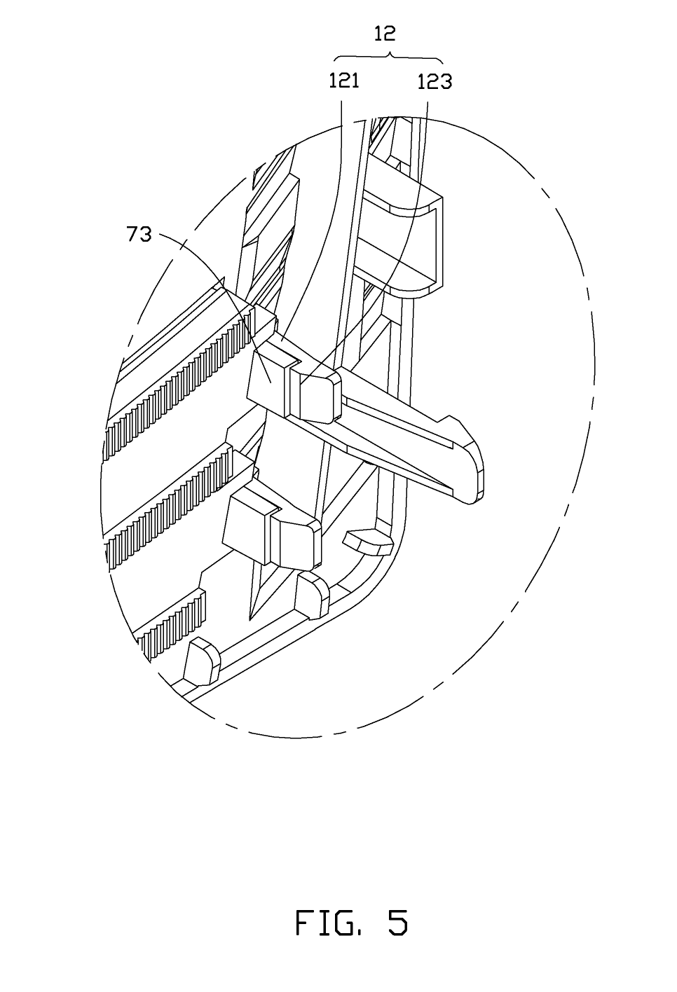

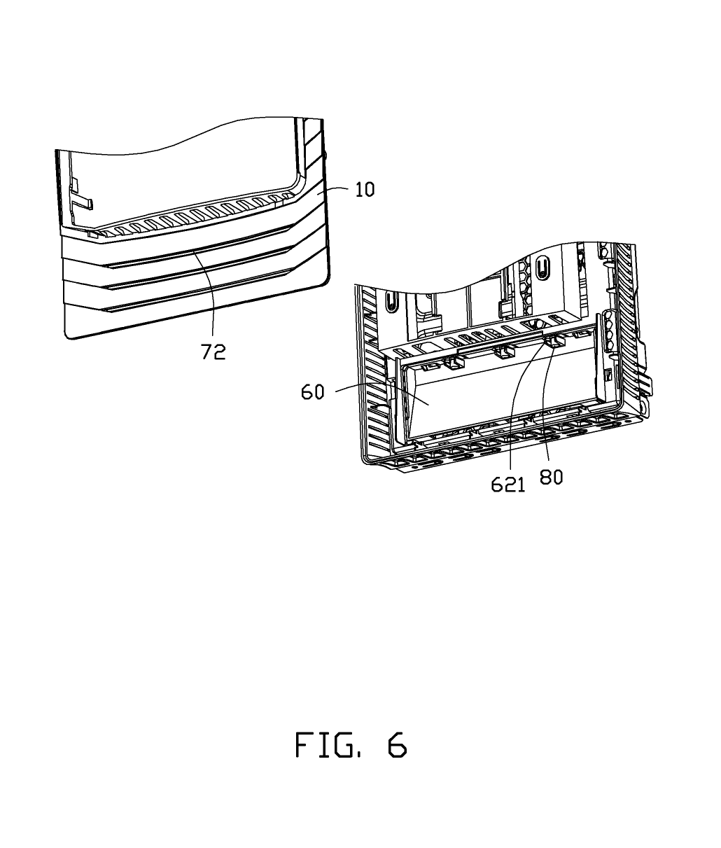

FIGS. 4-7 show that, in assembly, the lamp 80 is moved towards the securing portion 621 to elastically deform the two resilient pieces 6211. The lamp 80 is received in the receiving slot 6213. The two resilient pieces 6211 rebound to engage and lock the lamp 80 in the receiving slot 6213.

The installation plate 20 is placed to be adjacent to the mounting plate 30, and the second hook 231 is aligned with the second latching slot 331. The installation plate 20 is moved towards the mounting plate 30 until the second hook 231 engages in the second latching slot 331. The installation plate 20 is thereby secured to the mounting plate 30.

The lamp duct 60 is placed in the receiving opening 211. The installation portion 611 is engaged in the mounting portion 3123 through the guiding portion 3121. The third hook 623 is engaged in the mounting hole 311. The lamp duct 60 is thereby secured to the mounting plate 30, and the duct body 61 is received in the receiving opening 211.

The light guiding board 70 is placed adjacent to the front plate 10, and the tab 73 is aligned with the latching portion 12. When the light guiding board 70 is moved, the tab 73 elastically deforms the latching portion 12, until the tab 73 slides over the latching block 123, and the latching portion 12 rebounds to engage the light guiding board 70 in the front plate 10. The tab 73 is located between the two latching pieces 121 and between the latching block 123 and the first plate body 11. The light guiding rib 72 is aligned with the first slot 112.

The front plate 10 is placed adjacent to the installation plate 20, and the first hook 13 aligned with the first latching slot 2131. The front plate 10 is manipulated towards the installation plate 20 until the first hook 13 engages in the first latching slot 2131. The front plate 10 is thereby secured to the installation plate 20. The light guiding board 70 is located within the duct body 61 and under the lamp 80.

In use, when the electronic device plays music, a control module (not shown), such as a CPU, controls the one or more lamps 80 to emit light of different colors and different spans according to different volume or different amplitude of the music. The light is emitted out of the front plate 10 through the first slot 112 and the second slot 215 by the lamp duct 60 and the light guiding board 70. Thus, the front bezel 100 emits light thereby changing the appearance of the electronic device in accordance with the media being played. The one or more lamps 80 can emit lights of different colors and different spans across the front bezel 100, according to different music.

It is to be understood, however, that even though numerous characteristics and advantages have been set forth in the foregoing description of embodiments, together with details of the structures and functions of the embodiments, the disclosure is illustrative only and changes may be made in detail, especially in the matters of shape, size, and the arrangement of parts within the principles of the disclosure, to the full extent indicated by the broad general meaning of the terms in which the appended claims are expressed.

What is claimed is:

1. An electronic device enclosure comprising:
a front bezel defining a first slot and a second slot; and
a light assembly secured to the front bezel and comprising a lamp duct, a light guiding board, and a lamp;
wherein the lamp duct and the light guiding board are secured to the front bezel; the lamp is secured to the lamp duct; the light guiding board comprises a light guiding rib aligned with the first slot; when the lamp is switched on, a part of the light is guided to the second slot via the lamp duct, and another part of the light is guided by the light guiding board and the light guiding rib and emitted out of the front bezel through the first slot.

2. The electronic device enclosure of claim 1, wherein an extending direction of the first slot is substantially perpendicular to an extending direction of the second slot.

3. The electronic device enclosure of claim 1, wherein the lamp duct comprises a duct body and a top wall connected to the duct body; the lamp is secured to the top wall; and the light guiding board is received in the duct body.

4. The electronic device enclosure of claim 3, wherein the top wall comprises a securing portion, the securing portion comprises two resilient pieces, and each of the two resilient pieces defines a receiving slot; and the lamp is received in the receiving slots of the two resilient pieces.

5. The electronic device enclosure of claim 3, wherein the front bezel comprises a front plate, an installation plate, and a mounting plate; the installation plate is secured to the mounting plate; the front plate is secured to the installation plate; the installation plate defines a receiving opening, and the light guiding board is secured to the front plate and received in the receiving opening; and the light guiding board is engaged with the mounting plate.

6. The electronic device enclosure of claim 5, wherein the front plate comprises two latching portions opposite to each other, each latching portion comprises a latching piece and a latching block located on the latching piece; the light guiding board comprises two tabs opposite to each other; the two tabs are located between the latching pieces of the two latching portions; and the latching block engages the light guiding board with the front plate.

7. The electronic device enclosure of claim 6, wherein the two tabs are substantially parallel to each other, the latching pieces of the two latching portions are substantially parallel to each other, and a distance between the two tabs are substantially equal to a distance between the latching pieces of the two latching portions.

8. The electronic device enclosure of claim 5, wherein the lamp duct further comprises an installation portion, and the installation portion comprises a connecting piece extending from the duct body and a mounting piece perpendicularly extending from the connecting piece; the mounting plate defines a mounting slot, and the mounting slot comprises a guiding portion and a mounting portion; and the installation portion is engaged in the mounting portion through the guiding portion.

9. The electronic device enclosure of claim 5, wherein the front plate comprises a first hook, the installation plate defines a first latching slot, and the first hook is engaged in the first latching slot; the installation plate comprises a second hook, the mounting plate defines a second latching slot, and the second hook is engaged in the second latching slot.

10. The electronic device enclosure of claim 5, wherein the first slot is defined in the front plate, and the second slot is under the receiving opening.

11. An electronic device enclosure comprising:
a front bezel the front bezel comprising a front plate, an installation plate, and a mounting plate; the installation plate being secured to the mounting plate; the front plate being secured to the installation plate; the light guiding board being secured to the front plate; and the light guiding board is engaged with the mounting plate; and
a light assembly secured to the front bezel and comprising a lamp duct secured to the front plate, a light guiding board secured to the mounting plate, and a lamp engaged in the lamp duct;
wherein the front plate defines a first slot; the installation plate defines a second slot; the light guiding board comprises a light guiding rib aligned with the first slot; when the lamp is switched on, a part of the light is guided to the second slot via the lamp duct, and another part of the light is guided by the light guiding board and the light guiding rib and emitted out of the front bezel through the first slot.

12. The electronic device enclosure of claim 11, wherein an extending direction of the first slot is substantially perpendicular to an extending direction of the second slot.

13. The electronic device enclosure of claim 11, wherein the lamp duct comprises a duct body and a top wall connected to the duct body; the lamp is secured to the top wall; and the light guiding board is received in the duct body.

14. The electronic device enclosure of claim 13, wherein the top wall comprises a securing portion, the securing portion comprises two resilient pieces, and each of the two resilient pieces defines a receiving slot; and the lamp is received in the receiving slots of the two resilient pieces.

15. The electronic device enclosure of claim 13, wherein the lamp duct further comprises an installation portion, and the installation portion comprises a connecting piece extending from the duct body and a mounting piece extending substantially perpendicularly from the connecting piece; the mounting plate defines a mounting slot, and the mounting slot comprises a guiding portion and a mounting portion; and the installation portion is engaged in the mounting portion through the guiding portion.

16. The electronic device enclosure of claim 11, wherein the installation plate defines a receiving opening, and the light guiding board is received in the receiving opening.

17. The electronic device enclosure of claim 16, wherein the second slot is under the receiving opening.

18. The electronic device enclosure of claim 11, wherein the front plate comprises two latching portions opposite to each other, each latching portion comprises a latching piece and a latching block located on the latching piece; the light guiding board comprises two tabs opposite to each other; the two tabs are located between the latching pieces of the two latching portions; and the latching block engages the light guiding board with the front plate.

19. The electronic device enclosure of claim 18, wherein the two tabs are substantially parallel to each other, the latching pieces of the two latching portions are substantially parallel to each other, and a distance between the two tabs are substantially equal to a distance between the latching pieces of the two latching portions.

20. The electronic device enclosure of claim 11, wherein the front plate comprises a first hook, the installation plate defines a first latching slot, and the first hook is engaged in the first latching slot; the installation plate comprises a second hook, the mounting plate defines a second latching slot, and the second hook is engaged in the second latching slot.
